(19) United States
(12) Patent Application Publication
(10) Pub. No.: US 2019/0295082 A1
(43) Pub. Date: Sep. 26, 2019

(54) Message Based Payment Card System, Apparatuses, and Method Thereof

(71) Applicant: MASTERCARD INTERNATIONAL INCORPORATED, Purchase, NY (US)

(72) Inventors: Adam J. Telem, New York, NY (US); Andrew Buckley, Kenilworth (GB); Mohit Bijlani, Fort Lee, NJ (US)

(73) Assignee: MASTERCARD INTERNATIONAL INCORPORATED, Purchase, NY (US)

(21) Appl. No.: 16/363,757

(22) Filed: Mar. 25, 2019

Related U.S. Application Data
(60) Provisional application No. 62/647,376, filed on Mar. 23, 2018.
(60) Provisional application No. 62/647,408, filed on Mar. 23, 2018.

(51) Int. Cl. G06Q 20/40; G06Q 20/02; G06N 5/02; G06N 20/00

(52) U.S. Cl. CPC G06Q 20/409; G06N 20/00; G06N 5/02; G06Q 20/027

(57) ABSTRACT

A payment card system comprising an artificial intelligence (AI) platform configured to: acquire, via a first communication channel, payment card information associated with a user; identify a payment card account of the user based on the payment card information; receive from the user, via the first communication channel, a command related to a function to be performed with respect to the payment card account; and transmit the command, via a second communication channel, to a remote device in a bank-related network; and the remote device of the bank-related network. The payment card system also comprises a remote device. The remote device comprises: a memory; a receiver configured to receive the command transmitted from the AI platform; and a processor coupled to the memory, the processor configured to: authenticate the user in the bank-related network, wherein the first communication channel is different from the second communication channel.

### CROSS REFERENCE TO RELATED APPLICATIONS

This application claims benefit of priority to U.S. Provisional Patent Application No. 62/647,376 and U.S. Provisional Patent Application No. 62/647,408, both filed Mar. 23, 2018, the contents and disclosure of which are hereby incorporated by reference herein in their entirety.

### BACKGROUND

Payment card programs, including, for example, prepaid card programs, do not enable core functions (e.g., balance inquiries or top up with respect to prepaid cards) through consolidated, digital channels. Conventional programs either require card users to call into a service center, go online via their computer or, assuming both that the user has a smartphone and that the card-issuer enables such functionality, use an app developed by a card-related entity to perform core account functions.

### SUMMARY

Consistent with the disclosure, exemplary embodiments of systems, apparatuses, and methods for enabling message-based communication for performing core functions with respect to payment card accounts, are disclosed.

According to an embodiment, there is provided a payment card system. The payment card system may include: an artificial intelligence (AI) platform configured to: acquire, via a first communication channel, payment card information associated with a user; identify a payment card account of the user based on the payment card information; receive from the user, via the first communication channel, a command related to a function to be performed with respect to the payment card account; and transmit the command, via a second communication channel, to a remote device in a bank-related network. The payment card system also includes the remote device of the bank-related network, the remote device comprising: a memory; a receiver configured to receive the command transmitted from the AI platform; and a processor coupled to the memory, the processor configured to authenticate the user in the bank-related network, wherein the first communication channel is different from the second communication channel.

The user may be authenticated with the AI platform via the first communication channel, the first communication channel may be a message or messenger-based channel, and the user may communicate via a mobile device with the AI platform to authenticate the user with the AI platform.

The function may be related to at least one of a balance inquiry, balance top-up, or balance transfer.

The AI platform may be connected with the bank-related network via the second communication channel, and the bank-related network may include at least one of an issuer entity, an acquirer entity, or a card manufacturing company.

The user may be authenticated with an entity in the bank-related network using a third communication channel, the third communication channel being between the mobile device of the user and the bank-related network.

According to another exemplary embodiment, there is provided a payment card account service method. The method may include: acquiring, via a first communication channel, payment card information associated with a user; identifying a payment card account of the user based on the payment card information; receiving from the user, via the first communication channel, a command related to a function to be performed with respect to the payment card account; and transmitting the command, via a second communication channel, to a bank-related network, wherein the first communication channel is different from the second communication channel.

The method may further include authenticating a user with an artificial intelligence (AI) bot via the first communication channel, wherein the first communication channel is a message or messenger-based channel and the user communicates via a mobile device with the AI bot to perform the authentication.

The function of the method may be related to at least one of a balance inquiry, balance top-up, and balance transfer.

The network of the AI bot may be connected with the bank-related network via the second communication channel, wherein the bank-related network includes at least one of an issuer entity, an acquirer entity, and a card manufacturing company.

The user may be authenticated with an entity in the bank-related network using a third communication channel, the third communication channel being between the mobile device of the user and the bank-related network.

According to yet another exemplary embodiment, there is provided at least one non-transitory computer readable storage medium. The at least one non-transitory computer readable storage medium may include a set of instructions which, when executed by a computing device, cause the computing device to: acquire, via a first communication channel, payment card information associated with a user; identify a payment card account of the user based on the payment card information; receive from the user, via the first communication channel, a command related to a function to be performed with respect to the payment card account; and transmit the command, via a second communication channel, to a bank-related network, wherein the first communication channel is different from the second communication channel.

The function may be related to at least one of a balance inquiry, balance top-up, and balance transfer.

The network of the AI bot may be connected with the bank-related network via the second communication channel, wherein the bank-related network includes at least one of an issuer entity, an acquirer entity, and a card manufacturing company.

The user may be authenticated with an entity in the bank-related network using a third communication channel, the third communication channel being between the mobile device of the user and the bank-related network.

According to yet another exemplary embodiment, there is provided an artificial intelligence (AI) system. The AI system may include: a processor; and logic communicatively coupled to the processor to: determine, via a first communication channel, payment card information associated with a cardholder and a command related to a function to be performed with respect to a payment card account; identify the payment card account of the cardholder based on the payment card information; and cause a transmitter module to transmit the command, via a second communication channel, to a bank-related network, wherein the first communication channel is different from the second communication channel.

The user may be authenticated via the first communication channel, and the first communication channel may be a message or messenger-based channel.

The function may be related to at least one of a balance inquiry, balance top-up, or balance transfer.

The bank-related network may include at least one of an issuer entity, an acquirer entity, or a card manufacturing company.

The user may be authenticated with an entity in the bank-related network using a third communication channel, the third communication channel being between a mobile device of the user and the bank-related network.

It is to be understood that both the foregoing general description and the following detailed description are explanatory only and are not restrictive of this disclosure.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram illustrating a system for requesting a card balance according to an exemplary embodiment;

FIG. 2 illustrates a system for performing core functions with respect to a payment card account, using a message-based communication network and a bank-related network, according to an exemplary embodiment;

FIGS. 3A and 3B are block diagrams of an example of processing a request for a function to be performed with respect to a payment card account, according to an embodiment;

FIG. 4 illustrates a block diagram of a computing device according to an exemplary embodiment;

FIG. 5 is a block diagram of a semiconductor package apparatus according to an exemplary embodiment; and

FIG. 6 is a block diagram of another computing system according to an exemplary embodiment.

### GLOSSARY OF TERMS

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, Visa®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc. Use of the terms “credit card” or “credit card company” herein may refer to both the physical card or the card-producing company and/or non-physical accounts or the payment network companies that create the non-physical accounts.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### DESCRIPTION

Using an app to perform core banking functions (e.g., balance inquiries, transferring balances, topping off balances, etc.) is not always feasible as apps require internet connectivity and that the users of the apps have data plans so that the apps can connect to backend servers to perform whatever core functions are being requested. Further, access to core functionality is traditionally delivered through a payment card issuer whom, for varying reasons, may not have made the necessary investments in technology to deliver a positive, effective, and convenient experience to its cardholders. Thus, certain conveniences to cardholders may be limited.

There is no consolidated channel for cardholders, particularly those who only have feature phones, to have access to core functions that is issuer agnostic, payment-brand agnostic, and is provided in a consumer-friendly fashion.

An additional problem of the conventional art is that even when, for example, an issuer, provides an app, cardholders that have multiple payment cards may need to download an app for each respective card provider in order to perform core functions with respect to each payment card. Thus, prior to the solutions described herein, there was no consolidated channel for performing core functions on all payment cards regardless of card issuer and payment-brand. Additionally, having to download multiple apps takes up space on a user's device and reduces the amount of memory a device may use for other apps or programs. Also, to perform core functions with respect to different payment card accounts, a user must open each account's app, which is time-consuming and inefficient.

The inefficiencies and resource-consuming aspects of the above-mentioned problems of conventional technology to perform core functions with respect to payment card accounts significantly contribute to millions of transactions being declined or rejected daily. This taxes payment card systems and programs due to the subsequent follow-up and inquiry-actions (both virtually and manually) that must be taken by a user (or merchant) after a transaction is declined. For example, the vast majority of declines in prepaid card transactions (globally) are a result of there being an insufficient balance on the card. Such transaction-declines place a significant and unnecessary strain on conventional payment card systems as well as consumers. There are numerous statistics that show the tremendous strain on payment card systems. For example, less than half of all cross-border transactions with prepaid cards from Brazil into the United States (e.g., Netflix) are approved. Such strain occurs, at least in part, because there is no efficient, convenient, and easy way for consumers to perform core functions without a computer, smartphone apps, or having to call a service center concerning payment card accounts to avoid or deal with declined or rejected transactions. Stated differently, having a consolidated channel to perform core functions should result in reduced declines, which would be to the benefit of the banks, the payment brands, and the consumer. There are long-standing problems in the conventional art, that have yet to be addressed in a satisfactory way prior to the solutions described hereinbelow.

While the concepts of the present disclosure are susceptible to various modifications and alternative forms, specific embodiments have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” an illustrative embodiment,” etc., indicate that the embodiment described may include a particular feature, structure, or characteristic, but every embodiment may or may not necessarily include that particular feature, structure, or characteristic. Further, when a particular feature, structure, or characteristic is described in connection with an embodiment, it is submitted that it is within the knowledge of one skilled in the art to affect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a machine readable (e.g., computer-readable) medium or machine-readable storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

Exemplary embodiments provide innovative and novel solutions by providing systems, methods, and apparatuses for performing core functions with respect to payment card programs/accounts using secure or non-secure message/messenger-based communication channels/platforms/networks (e.g., short message service (SMS), WHATSAPP, FACEBOOK Messenger, etc.). Hereinbelow, the terms “channel,” “platform,” and “network” may be used interchangeably, and these terms and related concepts are known and understood by skilled artisans. According to an exemplary embodiment, the disclosed solutions may be accomplished by combining a unique artificial intelligence (AI) platform/bot with message or messenger-based communication channels/platforms/networks (discussed below), and cross-communicating with, for example, existing bank-related networks, to enable the performance of core functions with respect to payment accounts. Exemplary embodiments also provide a single platform for performing core functions with respect to multiple different payment card accounts without having to download specific apps for each payment card account.

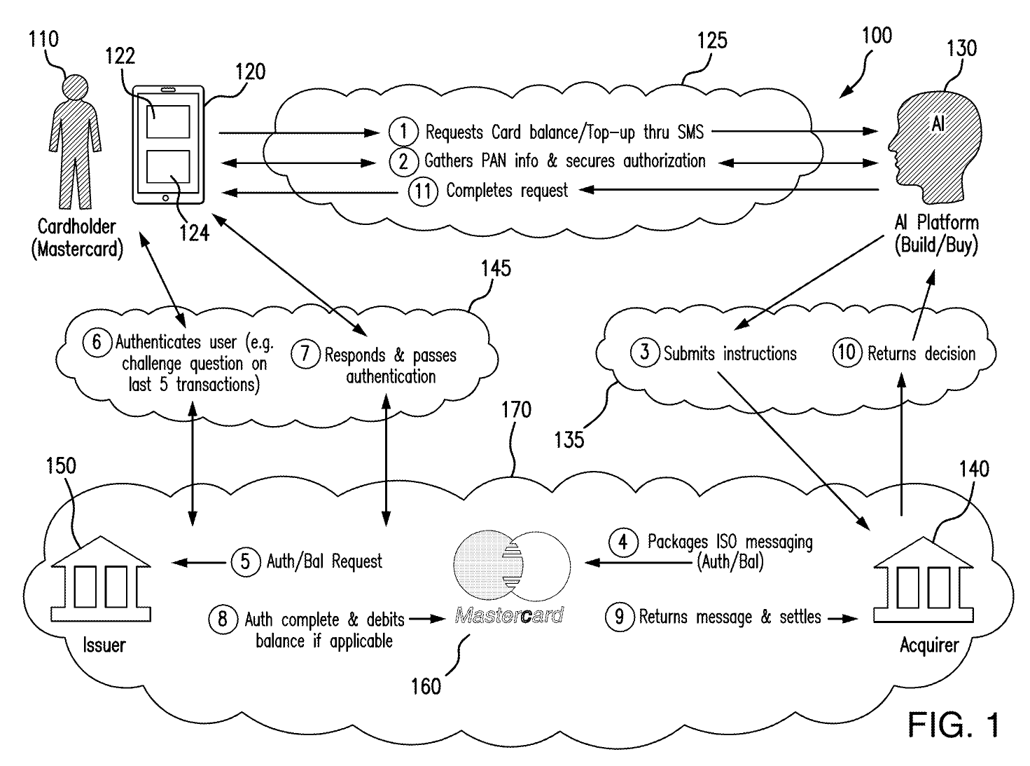

Referring now to FIG. 1, there is provided a block diagram illustrating a system for performing a core function with respect to a payment card account. According to the illustrated exemplary embodiment, a user/cardholder 110 may perform a core function of, for example, requesting a card balance or topping-up a payment card balance. For purposes of the description below with respect to FIG. 1, the focus is on the core function of requesting a payment card balance.

Using, for example, a mobile device 120, the user/cardholder 110 may request (operation 1) a card balance for a particular payment card using, for example, a message or messenger-based communication channel/platform/network 125. The channel/platform/network 125 (e.g., first communication channel) used for requesting the card balance may be implemented via a message or messenger-based communication channel/platform/network and/or via an app that uses the message or messenger-based communication channel/platform/network for communication. Thus, the balance request may be transmitted using an app on the mobile device 120 via a communication channel/platform/network for interacting with an AI BOT 130 (e.g., AI platform 130). The communication channel/platform/network for interacting with the AI BOT 130 may be a message or messenger-based channel/platform/network via which the AI BOT cross-communicates with the cardholder/user 110.

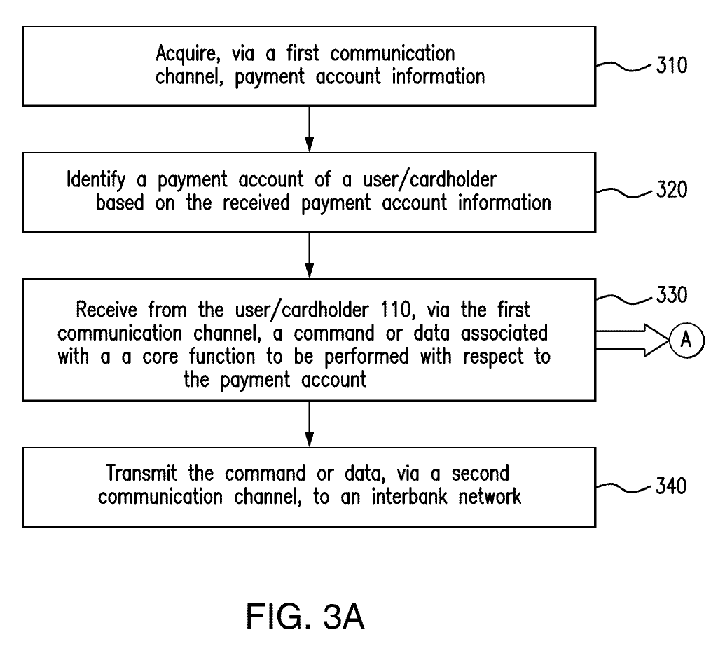

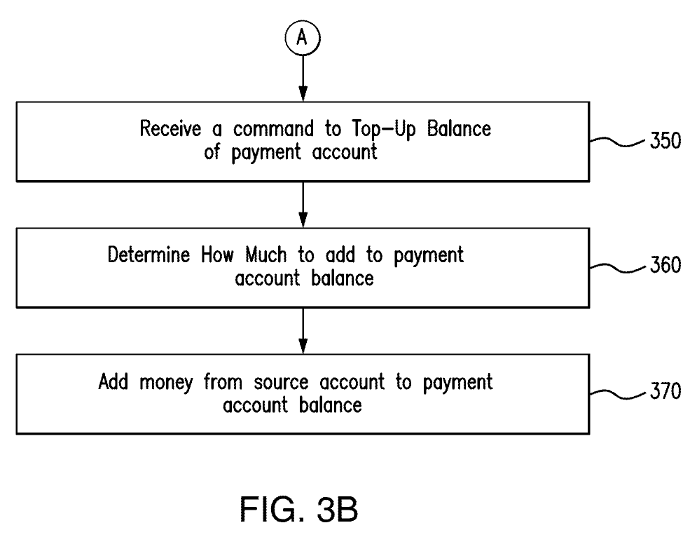

In response to the request (operation 1), the AI BOT 130 may obtain, via a first communication channel 125, payment account number (PAN) information of the user/cardholder 110, authenticate the user/cardholder 110, and secure authorization for the user/cardholder 110 to proceed with the balance inquiry with respect the particular payment card account (operation 2). The first communication channel 125 may be implemented using one or more different communication protocols, including, but not limited to, Short Message Service (SMS), Wideband Code Division Multiple Access (W-CDMA), Universal Mobile Telecommunications System (UMTS), CDMA2000 (IS-856/IS-2000), etc.), Wireless Fidelity (WiFi, e.g., IEEE 802.11-2007, Wireless Local Area Network (LAN) Medium Access Control (MAC) and Physical Layer (PHY) Specifications, etc.), Light Fidelity (LiFi, e.g., IEEE 802.15-7, Wireless LAN MAC and PHY, etc.), Long Term Evolution (LTE, e.g., 4G, 5G, etc.), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), etc. The AI BOT 130 may be implemented in one or more computing devices, such as, for example, the computing device illustrated in FIGS. 3A and 3B. Details of an exemplary computing device are discussed below with respect to FIG. 4.

The AI bot may convert the received balance inquiry command/request into a format that is compatible with a bank-related network 170 (e.g., interbank network or ATM network). For example, the AI bot may translate a request that reads, “what money do I have on card” into a standard command/request: “card balance”. This request may then be translated into an International Organization for Standardization (ISO) standard (e.g., ISO 8583) 128-bit map message, as described below.

In operation 3, the AI bot 130 may send, via a second communication channel/platform/network 135 (e.g., second communication channel), the command/request (or the converted command/request) related to the balance inquiry to, for example, an acquirer 140 in a bank-related network 170. The second communication channel 135 may implement a protocol that is the same, or separate and different from the first protocol implemented by the first communication channel 125. For example, the second communication channel 135 may implement an ISO standard message (e.g., ISO 8583) to define messages, data elements, and code value for communications in the second network. The standard may also define application and registration procedures for Institution Identification Codes (IIC) and maintenance procedures for the aforementioned messages, data elements, and code values.

The acquirer 140 may transmit the balance inquiry request command as a package/packet to a credit card company 160 operating a payment network or system, such as, for example, Mastercard® (operation 4). The credit card company 160 may transmit the balance request command to an issuer 150 (operation 5). The acquirer 140, credit card company 160, and issuer 150 may communicate within a bank-related network 170. The entities in the bank-related network 170 may communicate amongst each other using one or more communication protocols that are different from that which is implemented in the first communication channel 125 or second communication channel 135.

For additional security, according to an exemplary embodiment, an issuer 150 may initiate an additional authentication process with the user/cardholder 110 by, for example, directly communicating with the user/cardholder 110 (operation 6) via a third communication channel 145. The issuer 150 may authenticate the user/cardholder 110 by, for example, asking the user/cardholder 110 challenge questions. The authentication process that is performed via the third communication channel 145 is not limited to the asking of challenge questions. Known and unknown authentication procedures may be implemented via the third communication channel 145 to authenticate a user/cardholder 110. Once the user/cardholder 110 responds to the authentication questions of the issuer 150 and passes the authentication challenge(s) (operation 7), the issuer 150 may provide the credit card company with the requested account balance data (operation 8).

Credit card company 160 may then return the account balance data to the acquirer 140 (operation 9). The acquirer 140 may then provide, via the second communication channel 135, the account balance data related to the balance request to the AI BOT 130 for transmission to the user/cardholder 110 via the first communication channel (operations 10 and 11).

FIG. 1 illustrates an exemplary system and process flow, but in other exemplary embodiments, one or more of the illustrated bank network nodes (e.g., acquirer, credit card company, or issuer) or one or more of the illustrated operations may or may not be necessary to complete the balance inquiry request. According to an exemplary embodiment, operations 3-10 may be performed on one or more ATM networks (e.g., Cirrus, Mastercard's network, LINK, etc) and/or existing bank-related network implementing International Organization for Standardization (ISO) standards for bank networks (e.g., worldwide ATM network). Operations 1, 2, and 11, which involve communications between the user/cardholder 110 and the AI BOT 130, may be performed via a first communication channel 125 (e.g., a message or messenger-based communication channel/platform/network or using message or messenger-based app).

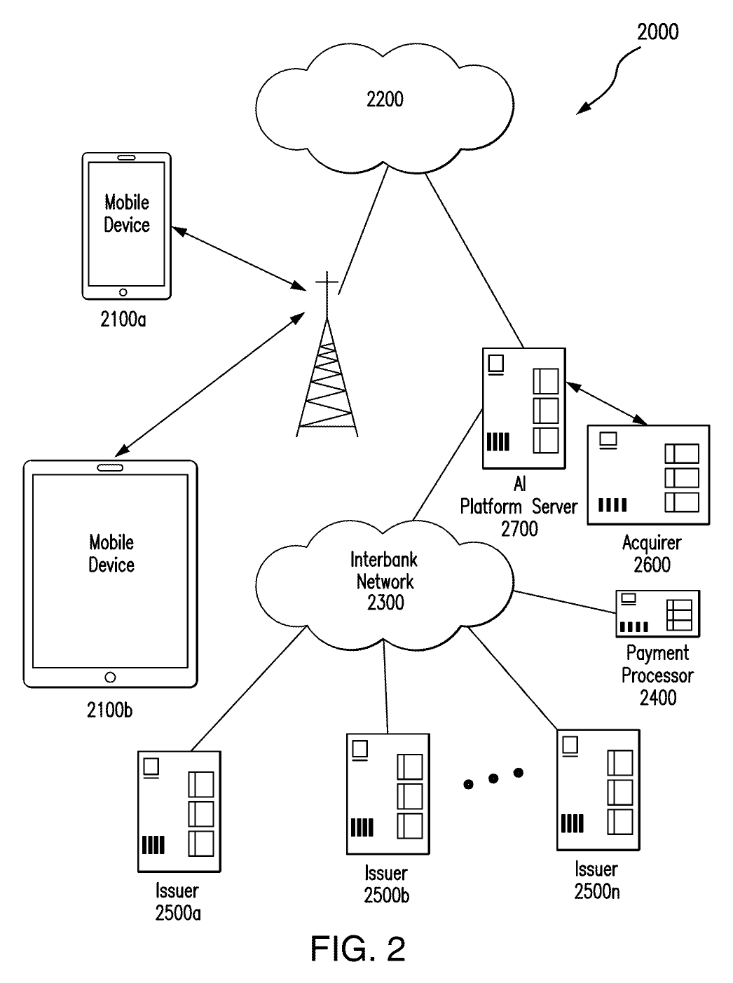

FIG. 2 illustrates an exemplary embodiment of another system 2000 configured to enable core functions with respect to a payment card account. System 2000 illustrates payment cardholders respectively using one or more mobile devices 2100a/2100b to connect to an AI platform server 2700 via a message or messenger-based communication channel/platform/network 2200. (i.e., a first communication channel).

Mobile computing devices 2100a/2100b may include mobile devices such as mobile telephones, tablet computers, laptop computers, “ultra-books” or other portable computing devices known in the art as being capable of communicating with AI platform server 2700 via the message or messenger-based communication channel/platform/network 2200.

As shown in FIG. 2, AI platform server 2700 may be communicatively connected to a payment processor 2400, an acquirer 2600, and issuers 2500a-n via an interbank network 2300. According to an exemplary embodiment, a payment network (not shown) may be implemented instead of a payment processor 2400 to process payments electronically. An example of a payment processor 2400 is Mastercard International Incorporated.

The system of FIG. 2 is different from FIG. 1 in various ways. For example, FIG. 2 does not illustrate a third communication channel between an issuer and the cardholder's device. Additionally, as illustrated in FIG. 2, an acquirer 2600 may not be a part of an interbank network 2300.

Above, the core function of performing a balance inquiry is described with respect to FIG. 1. ‘Balance top-up’, ‘Produce a mini-statement of recent transactions,’ and ‘transferring a balance’ are additional core functions that may be performed according to the exemplary solutions described herein and may be performed within a system such as that shown in FIG. 2. Other core functions may be performed in accordance with exemplary embodiments.

Referring now to FIG. 3A, there is illustrated a method of processing a core function with respect to a payment card account according to an exemplary embodiment. In block 310, an AI platform/BOT 130 may acquire, via a first communication channel, payment card information that is transmitted from a mobile device 120 of a user/cardholder 110. The AI platform/BOT 130 may be implemented in a computing device, such as the computing device illustrated in FIG. 4. In block 320, the AI platform 130 may identify a payment card account of a user/cardholder 110 based on the received payment card information. The AI platform 130 may identify the payment card account of the user/cardholder 110 independently or may communicate with other nodes within, for example, a bank-related network (e.g., interbank network) to determine a payment card account of a user/cardholder 110.

In block 330, the AI platform/BOT 130 may receive from the user/cardholder 110, via the first communication channel (e.g., a message or messenger-based channel/platform/network), a command or data associated with a core function to be performed with respect to the payment card account. As discussed above, the requested function may be one or more of a number of core functions/actions that a cardholder might typically take with respect to payment card accounts, including, but not limited to, requesting a balance inquiry, balance top-up, balance transfer, etc.

In block 340, the AI platform 130 may transmit the command or data, via a second communication channel, to a bank-related network (e.g., an interbank network). According to an exemplary embodiment, to transmit the command or data, the command or data may be converted, algorithmically processed and/or manipulated into a format that is compatible with, for example, the interbank network, which is a different communication channel/platform/network from the first communication channel (e.g., the message or messenger-based communication channel/platform/network). The first communication channel and the interbank network may utilize different protocols for communication. The interbank network may also implement one or more communication protocols that are different from that which is implemented in the second communication channel. According to an exemplary embodiment, a potential result of a disclosed solution may be that a card issuer within the interbank network does not need to modify existing technology or protocols due to a conversion that may be implemented.

FIG. 3B illustrates the processing of a command related to topping up a payment card account balance. In block 350, an AI platform 130 may receive a command related to topping up a payment card account balance. In block 360, the AI platform 130 may determine how much to add to the payment card account balance. The AI platform 130 may make this determination by automatically communicating with a user/cardholder 110 via a first communication channel or may automatically identify a source from which to draw funds to add to the payment card account balance based on a pre-set protocol. The AI platform 130 may identify the source by communicating with a bank-related network via a second communication channel that is different from the first communication channel. In block 370, the AI platform 130 may add money from the identified source account to the payment card account balance.

The method illustrated in FIGS. 3A and 3B may be implemented in a computing device or system. The computing device or system may be a user level device or system or a server-level device or system. More particularly, the methods may be implemented in one or more modules as a set of logic instructions stored in a machine or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the methods of FIGS. 3A and 3B may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, and/or other structural components that are native to hardware (e.g., host processor, central processing unit/CPU, microcontroller, etc.).

Referring now to FIG. 4, an exemplary computing device 400 (e.g., an AI platform/BOT 130) for performing the methods of FIGS. 3A and 3B is shown. The computing device 400 may include a processor 420, a memory 426, a data storage 428, a communication subsystem 430 (e.g., transmitter, receiver, transceiver, etc.), and an I/O subsystem 424. Additionally, in some embodiments, one or more of the illustrative components may be incorporated in, or otherwise form a portion of, another component. For example, the memory 426, or portions thereof, may be incorporated in the processor 420 in some embodiments. The computing device 300 may be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device. Additionally, the computing device 400 may be one of several computing devices used to perform the methods of FIGS. 3A and 3B, where computational resources may be shared between the several different computing devices.

The processor 420 may be embodied as any type of processor capable of performing the functions described herein. For example, the processor 420 may be embodied as a single or multi-core processor(s), digital signal processor, microcontroller, or other processor or processing/controlling circuit.

The memory 426 may be embodied as any type of volatile or non-volatile memory or data storage capable of performing the functions described herein. In operation, the memory 426 may store various data and software used during operation of the computing device 400 such as operating systems, applications, programs, libraries, and drivers. The memory 426 is communicatively coupled to the processor 420 via the I/O subsystem 424, which may be embodied as circuitry and/or components to facilitate input/output operations with the processor 420, the memory 426, and other components of the computing device 400.

The data storage device 428 may be embodied as any type of device or devices configured for short-term or long-term storage of data such as, for example, memory devices and circuits, memory cards, hard disk drives, solid-state drives, non-volatile flash memory, or other data storage devices.

The computing device 400 may also include a communications subsystem 430, which may be embodied as any communication circuit, device, or collection thereof, capable of enabling communications between the computing device 400 and other remote devices over a computer network (not shown). The communications subsystem 430 may be configured to use any one or more communication technology (e.g., wired or wireless communications) and associated protocols (e.g., Ethernet, Bluetooth®, Wi-Fi®, WiMAX, LTE, etc.) to affect such communication. The communications subsystem 430 may be configured to simultaneously or sequentially communicate over a message or messenger-based communication channel/network/platform and any type of separate channel, including, but not limited to, a bank-related network (e.g., interbank network).

As shown, the computing device 400 may further include one or more peripheral devices 432. The peripheral devices 432 may include any number of additional input/output devices, interface devices, and/or other peripheral devices. For example, in some embodiments, the peripheral devices 432 may include a display, touch screen, graphics circuitry, keyboard, mouse, speaker system, microphone, network interface, and/or other input/output devices, interface devices, and/or peripheral devices. The computing device 400 may also perform one or more of the functions described in detail herein and/or may store any of the data or information referred to herein as it relates to the AI platform/BOT 430.

The computing device 400 may further include machine learner logic 440 and authenticator logic 450. The machine learner logic 440 learns communication patterns associated with respective users/cardholders and may tailor the choices of words used for communication to specific cardholders (users/cardholders may use natural language to communicate with the computing device 400/AI bot). In one example, the machine learner logic 440 of the computing device (i.e., the AI bot) may learn how a particular user prefers to communicate (e.g., formal dialog, colloquial or relaxed dialog, etc.). Such learning may be performed passively and/or continually. The authenticator logic 450 may authenticate a cardholder so that a cardholder may access his or her account information.

While examples have provided various components of the computing device 400 for illustration purposes, it should be understood that one or more components of the computing device 400 may reside in the same and/or different physical and/or virtual locations, may be combined, omitted, bypassed, re-arranged, and/or be utilized in any order. For example, the machine learner logic 440 and/or the authenticator logic 450 may reside in the same and/or different physical and/or virtual locations as a component of the computing device 400 (e.g., both may reside in the processor). Moreover, any or all components of the computing device 400 may be automatically implemented (e.g., without human intervention, etc.).

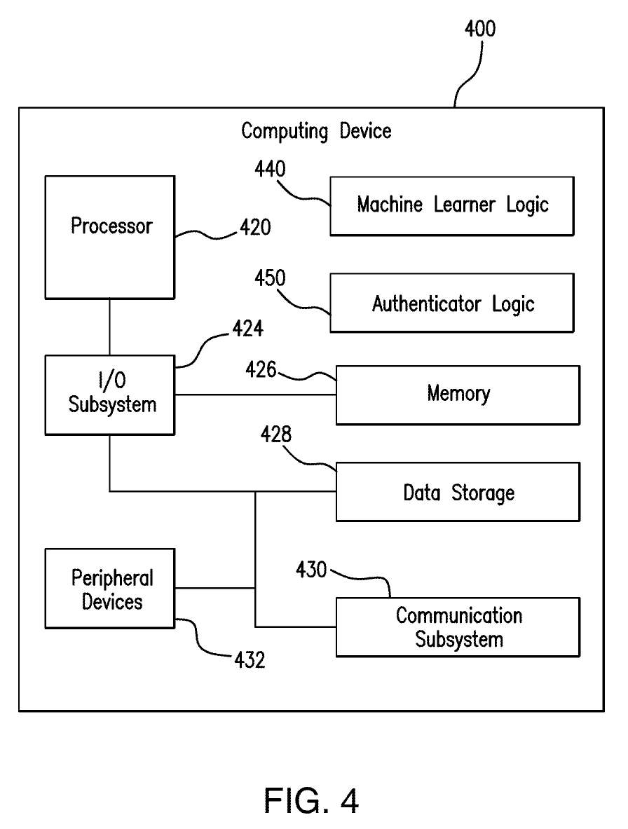

Turning now to FIG. 5, an embodiment of a semiconductor package apparatus 510 includes one or more substrates 512 (e.g., silicon, sapphire, gallium arsenide, etc.) and machine learner/authenticator logic 514 (e.g., transistor array and other integrated circuit/IC components, etc.) coupled to the substrates 512. The apparatus 510 may be implemented in one or more components of the system 100 (FIG. 1) and/or computing device 400 (FIG. 4), already discussed. Moreover, the apparatus 510 may implement one or more of the aspects of the method of FIGS. 3A and 3B, already discussed.

Embodiments of the machine learner/authenticator logic 514, and other components of the apparatus 510, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. In one example, the machine learner/authenticator logic 514 may include transistor channel regions positioned (e.g., embedded) within the substrates 512. Thus, the interface between the machine learner/authenticator logic 514 and the substrates 512 may not be an abrupt junction. The machine learner/authenticator logic 514 may also be considered to include an epitaxial layer that is grown on an initial wafer of the substrates 512.

Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

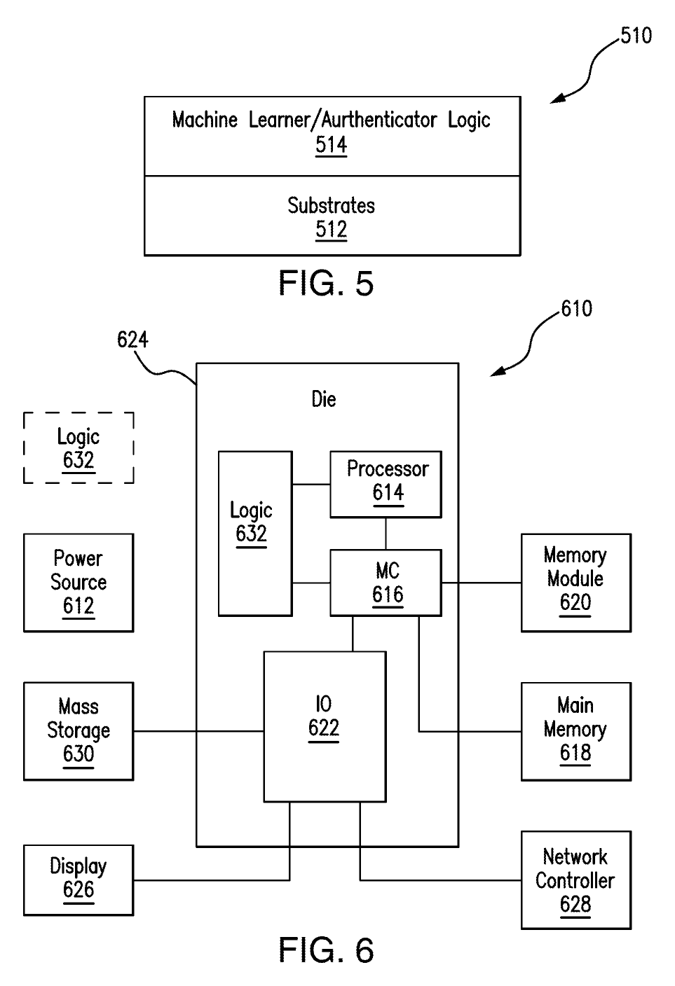

Turning now to FIG. 6, an example of an electronic processing system 610 is shown to provide machine learning and authentication according to an embodiment. The system 610 may generally be part of an electronic device/platform having computing functionality (e.g., datacenter, cloud server, personal digital assistant/PDA, notebook computer, tablet computer, laptop, etc.), imaging functionality (e.g., camera, projector, etc.), media playing functionality (e.g., smart television/TV, gaming platform, smart phone, etc.), wearable functionality (e.g., watch, eyewear, headwear, footwear, etc.), vehicular functionality (e.g., car, truck, motorcycle, etc.), communication functionality, and so on.

The system 610 includes a power source 612. The system 610 also includes a processor 614, such as a micro-processor, an embedded processor, a digital signal processor (DSP), a central processing unit (CPU), a graphical processing unit (GPU), a visual processing unit (VPU), a network processor, hardware that executes code to implement one or more aspects of the technology described herein, etc. For example, the processor 614 may include one or more cores to execute operations (e.g., a single-threaded core, a multithreaded core including more than one hardware thread context (or “logical processor”) per core, etc.). The processor 614 may also be coupled to internal storage such as a cache (e.g., instruction cache, data cache, single level cache, multilevel cache, shared cache, strictly inclusive cache, exclusive cache, etc.).

In the illustrated example, the processor 614 is communicatively coupled to a memory controller 616 that controls access to a memory device. The illustrated memory controller 616 is communicatively coupled to main memory 618. The main memory 618 may include, for example, RAM, ROM, PROM, EPROM, EEPROM, etc., PCM, 3D memory, etc. The memory controller 616 is also communicatively coupled to memory module 620. The memory module 620 may include, for example, DRAM configured as one or more memory modules such as dual inline memory modules (DIMMs), small outline DIMMs (SODIMMs), etc. Thus, the memory controller 616 may control direct memory access (DMA), remote DMA (RDMA), and so on.

The system 610 also includes an input output (TO) module 622 implemented together with the processor 614 and the memory controller 616 on a semiconductor die 624 as an SoC, wherein the IO module 622 functions as a host device and may communicate with, for example, a display 626 (e.g., touch screen, liquid crystal display/LCD, light emitting diode/LED display), a network controller 628 (e.g., Ethernet controller, etc.), and mass storage 630 (e.g., hard disk drive/HDD, optical disk, flash memory, etc.). The system 610 further includes logic 632 communicatively coupled to the processor 614, the memory controller 616, and the IO module 622 on the semiconductor die 624. The logic 632 may also be implemented elsewhere in the system 610 and/or outside of the system 610. The logic 632 may be the same as the machine learner/authenticator logic 514 (FIG. 5), already discussed. Moreover, the logic 532 may implement one or more of the aspects of the methods of FIGS. 3A and 3B, discussed above. Thus, the logic 632 provides passive biometric authentication and/or vehicle function control based on passive biometric authentication.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The flow diagrams and block diagrams in the Figures illustrate the architecture, functionality, and operation of possible implementations of systems, methods and computer program products according to various exemplary embodiments. In this regard, each block in the flow diagrams or block diagrams may represent a module, segment, or portion of code, which comprises one or more executable instructions for implementing the specified logical function(s). It should also be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow diagram illustrations, and combinations of blocks in the block diagrams and/or flowchart illustrations, may be implemented by special purpose hardware-based systems that perform the specified functions or acts, or combinations of special purpose hardware and computer instructions.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so on” or “etc.” may mean any combination of the listed terms as well with other terms.

The application titled “Multiple Card Message-Based Payment System, Apparatuses and Method Thereof”, filed on Mar. 25, 2019 and having the same inventors as the instant application, is hereby incorporated by reference herein in its entirety. This incorporation by reference is limited such that no subject matter is incorporated that is contrary to the explicit disclosure herein.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A payment card system comprising:
an artificial intelligence (AI) platform configured to:
acquire, via a first communication channel, payment card information associated with a user;
identify a payment card account of the user based on the payment card information;
receive from the user, via the first communication channel, a command related to a function to be performed with respect to the payment card account; and
transmit the command, via a second communication channel, to a remote device in a bank-related network; and
the remote device of the bank-related network, the remote device comprising:
a memory;
a receiver configured to receive the command transmitted from the AI platform; and
a processor coupled to the memory, the processor configured to:
authenticate the user in the bank-related network,
wherein the first communication channel is different from the second communication channel.

2. The system of claim 1, wherein the user is authenticated with the AI platform via the first communication channel,
wherein the first communication channel is a message or messenger-based channel, and
wherein the user communicates via a mobile device with the AI platform to authenticate the user with the AI platform.

3. The system of claim 1, wherein the function is related to at least one of a balance inquiry, balance top-up, and balance transfer.

4. The system of claim 1, wherein the AI platform is connected with the bank-related network via the second communication channel, and wherein the bank-related network includes at least one of an issuer entity, an acquirer entity, or a card manufacturing company.

5. The system of claim 4, wherein the user is authenticated with an entity in the bank-related network using a third communication channel, the third communication channel being between a mobile device of the user and the bank-related network.

6. A payment card account service method, the method comprising:
acquiring, via a first communication channel, payment card information associated with a user;
identifying a payment card account of the user based on the payment card information;
receiving from the user, via the first communication channel, a command related to a function to be performed with respect to the payment card account; and
transmitting the command, via a second communication channel, to a bank-related network,
wherein the first communication channel is different from the second communication channel.

7. The method of claim 6, further comprising:
authenticating the user with an artificial intelligence (AI) bot via the first communication channel,
wherein the first communication channel is a message or messenger-based channel and wherein the user communicates via a mobile device with the AI bot to perform the authentication.

8. The method of claim 6, wherein the function is related to at least one of a balance inquiry, balance top-up, or balance transfer.

9. The method of claim 6, wherein a network of the AI bot is connected with the bank-related network via the second communication channel, and wherein the bank-related network includes at least one of an issuer entity, an acquirer entity, or a card manufacturing company.

10. The method of claim 9, wherein the user is authenticated with an entity in the bank-related network using a third communication channel, the third communication channel being between a mobile device of the user and the bank-related network.

11. At least one non-transitory computer readable storage medium comprising a set of instructions which, when executed by a computing device, cause the computing device to:
acquire, via a first communication channel, payment card information associated with a user;
identify a payment card account of the user based on the payment card information;
receive from the user, via the first communication channel, a command related to a function to be performed with respect to the payment card account; and
transmit the command, via a second communication channel, to a bank-related network,
wherein the first communication channel is different from the second communication channel.

12. The at least one non-transitory computer readable storage medium of claim 11, which, when the set of instructions are executed by the computing device, cause the computing device to:
authenticate a user with an artificial intelligence (AI) bot via the first communication channel,
wherein the first communication channel is a message or messenger-based channel and wherein the user communicates via a mobile device with the AI bot to perform the authentication.

13. The at least one non-transitory computer readable storage medium of claim 11, wherein the function is related to at least one of a balance inquiry, balance top-up, or balance transfer.

14. The at least one non-transitory computer readable storage medium of claim 11, wherein a network of the AI bot is connected with the bank-related network via the second communication channel, wherein the bank-related network includes at least one of an issuer entity, an acquirer entity, or a card manufacturing company.

15. The at least one non-transitory computer readable storage medium of claim 14, wherein the user is authenticated with an entity in the bank-related network using a third communication channel, the third communication channel being between a mobile device of the user and the bank-related network.

16. An artificial intelligence (AI) system comprising:
a processor; and
logic communicatively coupled to the processor to:
determine, via a first communication channel, payment card information associated with a user and receive a command related to a function to be performed with respect to a payment card account;
identify the payment card account of the user based on the payment card information; and
cause a transmitter module to transmit the command, via a second communication channel, to a bank-related network,
wherein the first communication channel is different from the second communication channel.

17. The system of claim 16, wherein the user is authenticated via the first communication channel, and
wherein the first communication channel is a message or messenger-based channel.

18. The system of claim 16, wherein the function is related to at least one of a balance inquiry, balance top-up, or balance transfer.

19. The system of claim 16, wherein the bank-related network includes at least one of an issuer entity, an acquirer entity, or a card manufacturing company.

20. The system of claim 19, wherein the user is authenticated with an entity in the bank-related network using a third communication channel, the third communication channel being between a mobile device of the user and the bank-related network.
